(19) United States
(12) Patent Application Publication
(10) Pub. No.: US 2013/0135068 A1
(43) Pub. Date: May 30, 2013

(54) MAGNETIC ASSEMBLY

(71) Applicant: Leo Shih, Taichung (TW)

(72) Inventor: Leo Shih, Taichung (TW)

(21) Appl. No.: 13/308,163

(22) Filed: Nov. 30, 2011

(51) Int. Cl. H01F 7/02

(52) U.S. Cl. 335/302

(57) ABSTRACT

A magnetic assembly contains a magnetic member including two end portions with two different magnetic poles respectively and a groove fixed thereon in an axial direction, an exterior of the magnetic member and an exterior of the groove having magnetic fields surrounding therearound in different directions individually; a magnet guiding member with a magnetic permeability including a plate to contact with one end of the magnetic member, and the plate including a post extending outward therefrom to be fitted into the groove of the magnet guiding member.

### BACKGROUND OF THE INVENTION

1. Field of the Invention

The present invention relates to a magnetic assembly to enhance a magnetic flux density, a strength of a magnetic field, and a magnetic power and to save magnetic material.

2. Description of the Prior Art

With reference to FIG. 1, a conventional solid magnet 10 is formed in a circular disc shape and includes one end used as a N pole and another end as a S pole, an exterior of the solid magnet 10 generates a magnetic field surround therearound in the same direction. As shown in FIG. 2 and Appendixes 1 and 2, ½ cross section of the solid magnet 10 is captured, and distributions of a magnetic flux density and a magnetic potential are analyzed. As shown in Appendix 1, a magnetic flux of an outer periphery of the solid magnet 10 is intensive, and a maximum value of the magnetic flux of the outer periphery of the solid magnet 10 is 0.695 Wb/m2. As illustrated in Appendix 2, the outer periphery of the solid magnet 10 results in magnetic lines surrounding in the same direction, and strength of the magnetic field in relation to the magnetic flux is highest, a maximum value of the magnetic potential is 1.62e⁻³ Wb/m. Referring to FIG. 3, a conventional ring magnet 20 includes a groove 201 formed in a central position thereof in an axial direction, one end used as a N pole, and another end used as a S pole, an interior and an exterior of the ring magnet 20 generate magnetic fields surrounding therearound in different directions individually; as shown in FIG. 4 and Appendixes 3 and 4, ½ cross section of the ring magnet 20 is captured, and distributions of a magnetic flux density and a magnetic potential are analyzed. As illustrated in Appendix 3, magnetic fluxes of an inner periphery and an outer periphery of the ring magnet 20 are intensive, and a maximum value of the magnetic flux density is 0.695 Wb/m2, and as illustrated in Appendix 4, an interior of the ring magnet 20 generates magnetic lines surrounding therearound in a first direction (i.e., an anti-clockwise direction), and a magnetic potential value of a strength of the magnetic field relative to the magnetic flux in the first direction is −8.719e⁻⁴ Wb/m (this negative value represents the first direction), and an exterior of the ring magnet 20 generates magnetic lines surrounding therearound in a second direction (i.e., a clockwise direction), and a maximum value of a strength of the magnetic field relative to the magnetic flux in the second direction is 1.399e⁻³ Wb/m (this positive value represents the second direction), and a maximum value of a magnetic potential of the ring magnet 20 is 1.399e⁻³ Wb/m smaller than that (1.62e⁻³ Wb/m) of the magnetic potential of the solid magnet, so the groove 201 of the ring magnet 20 can save magnetic material but also influence the strength of the magnetic field. Referring to FIG. 5, the ring magnet 20 also includes an iron piece 21 with a magnetic permeability secured on one end surface thereof to increase a strength of the magnetic field; as illustrated in FIG. 6 and Appendixes 5 and 6, ½ cross sections of the ring magnet 20 and the iron piece 21 are captured, and distributions of magnetic flux densities and magnetic potentials are analyzed. As shown in Appendix 5, magnetic fluxes of an inner periphery and an outer periphery of the ring magnet 20 and the iron piece 21 are intensive, a maximum value of the magnetic flux density is 0.695 Wb/m2. Referring to Appendix 4, interiors of the ring magnet 20 and the iron piece 21 generate magnetic lines surrounding therearound in the first direction (i.e., the anti-clockwise direction), and a magnetic potential value of a strength of the magnetic field relative to the magnetic flux in the first direction is −1.272e⁻³ Wb/m (this negative value represents the first direction), and the exterior of the ring magnet 20 generates magnetic lines surrounding therearound in the second direction (i.e., the clockwise direction), and a maximum value of a strength of the magnetic field relative to the magnetic flux in the second direction is 1.537e⁻³ Wb/m (this positive value represents the second direction), and a maximum value of a magnetic potential of the ring magnet 20 with the iron piece 21 is 1.537e⁻³ Wb/m higher than that (1.399e⁻³ Wb/m) of the original magnetic potential but lower than that (1.62e⁻³ Wb/m) of the magnetic potential of a permanent magnet. Therefore, the ring magnet 20 with the iron piece 21 can save magnetic material but can not obtain a desired strength of the magnetic field.

The present invention has arisen to mitigate and/or obviate the afore-described disadvantages.

### SUMMARY OF THE INVENTION

The primary object of the present invention is to provide a magnetic assembly that is capable of applying the plate and the post of the magnet guiding member to guide and gather the surrounding path of the magnetic field of the magnetic member so that between the magnetic member and the magnet guiding member generates the magnetic flux density region, hence a magnetic flux density, a strength of a magnetic field, and a magnetic power are enhanced.

Another object of the present invention is to provide a magnetic assembly in which the maximum values of the magnetic flux density and the magnetic potential of the magnetic assembly are greater than a conventional solid magnet, a conventional ring magnet or a conventional magnet combining with an iron piece to enhance magnetic power and to save magnetic material.

To obtain the above objectives, a magnetic assembly provided by the present invention contains:

a magnetic member including two end portions with two different magnetic poles respectively and a groove fixed thereon in an axial direction, an exterior of the magnetic member and an exterior of the groove having magnetic fields surrounding therearound in different directions individually;

a magnet guiding member with a magnetic permeability including a plate to contact with one end of the magnetic member, and the plate including a post extending outward therefrom to be fitted into the groove of the magnet guiding member.

### BRIEF DESCRIPTION OF THE DRAWINGS

FIG. 1 is a perspective view of a conventional solid magnet;

FIG. 2 is a cross sectional view of the conventional solid magnet;

FIG. 3 is a perspective view of a conventional ring magnet;

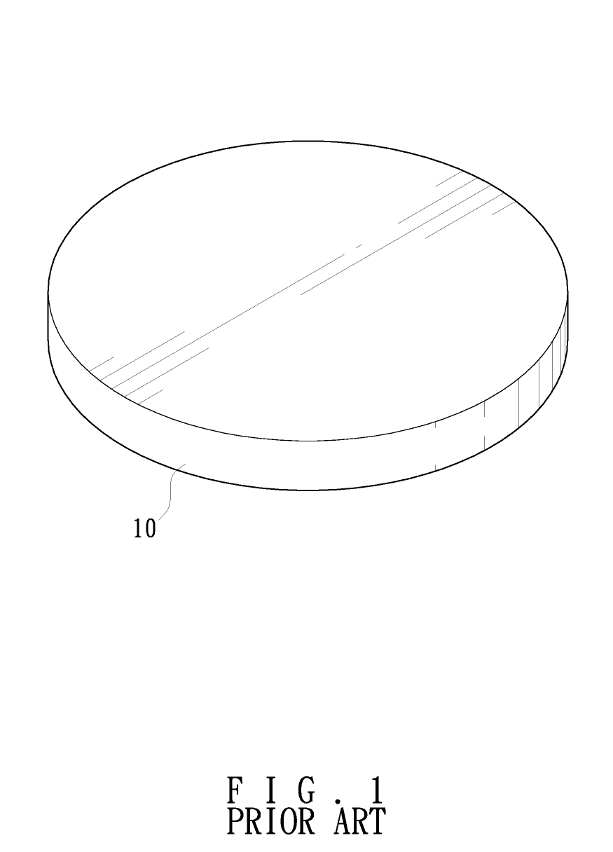

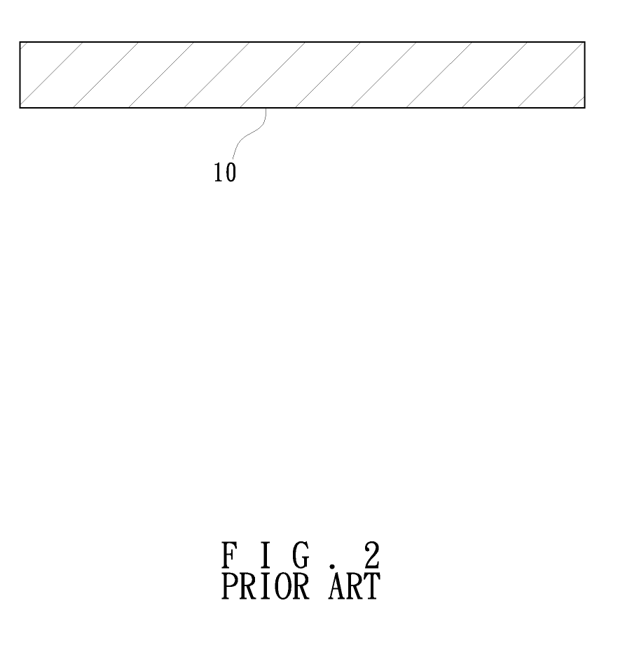

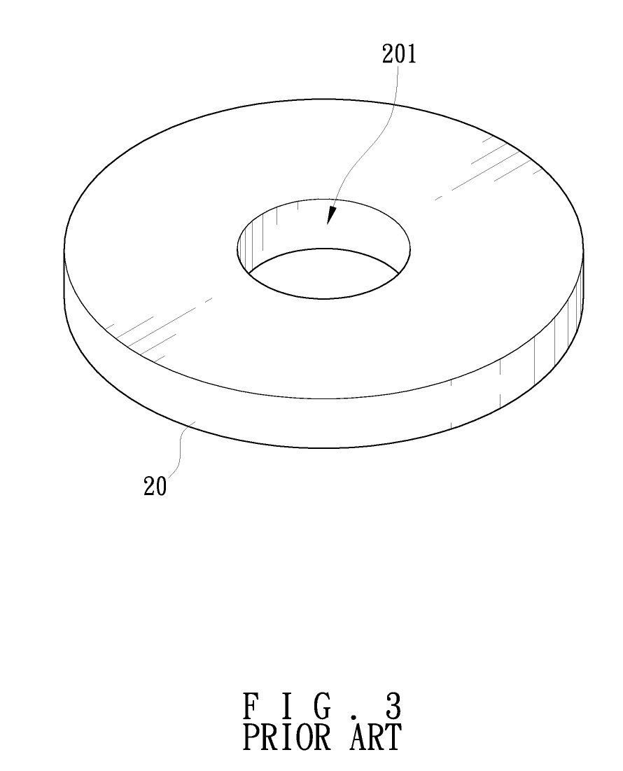

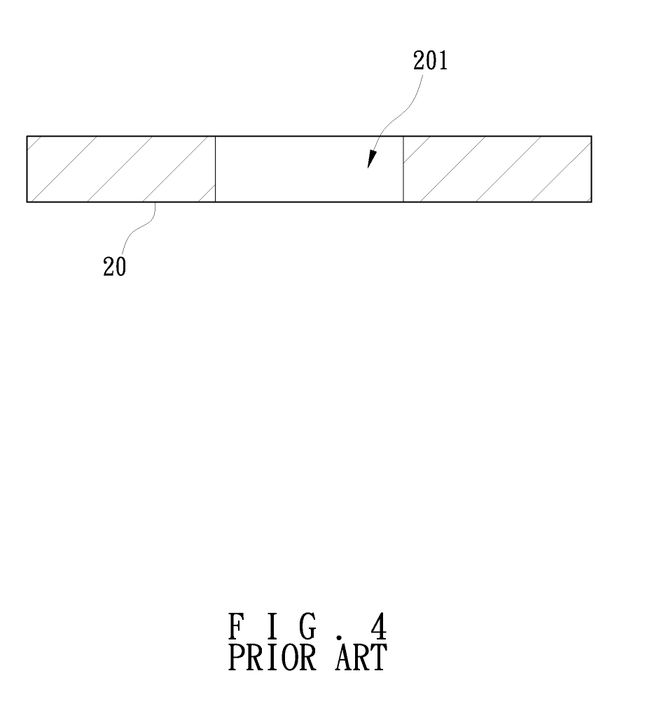

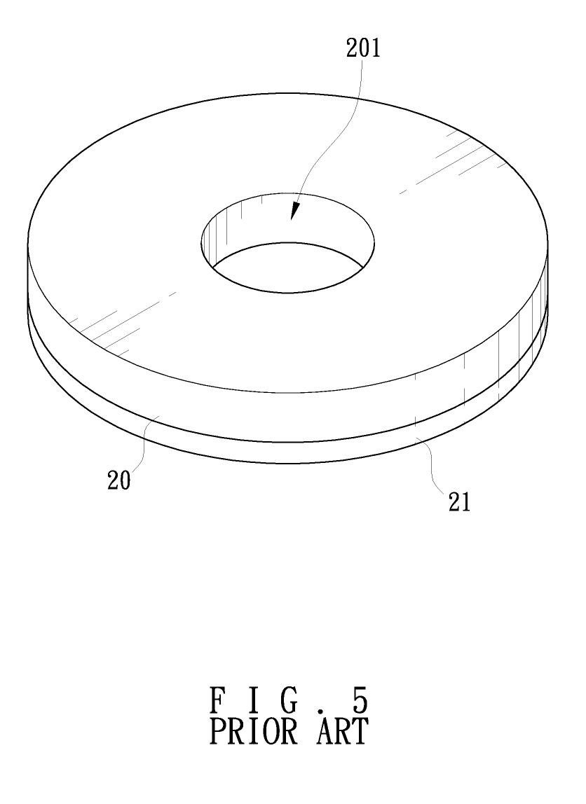

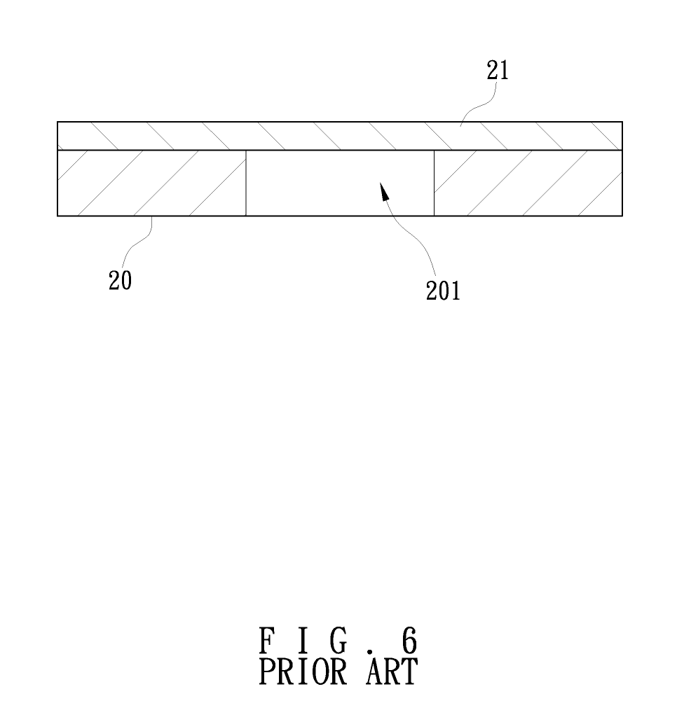

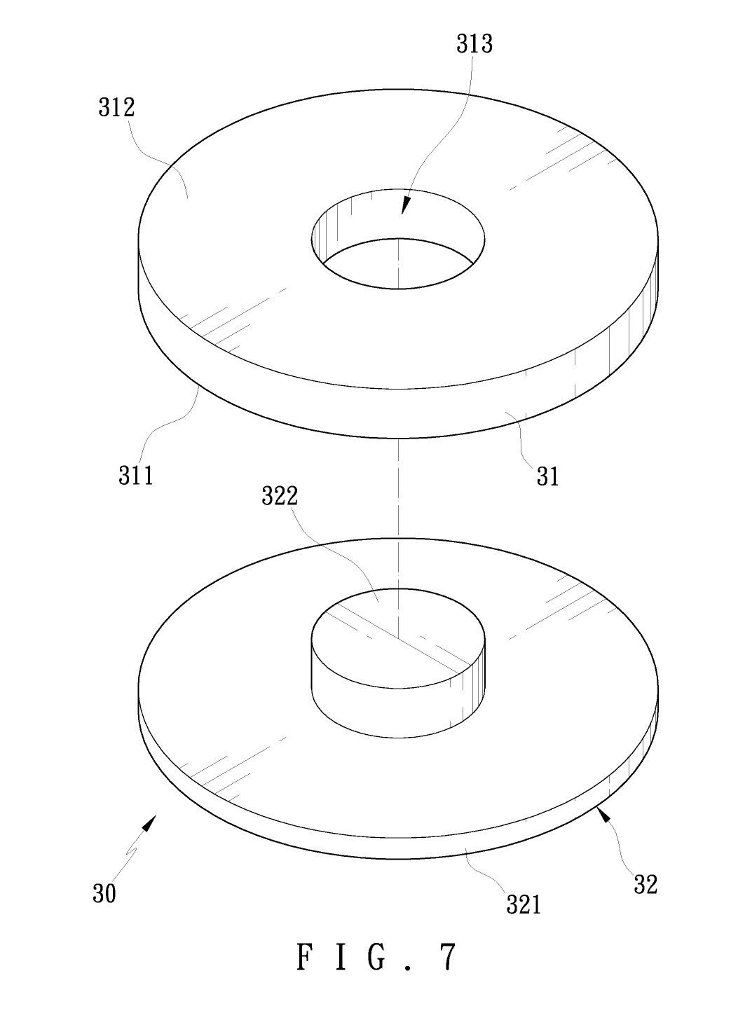

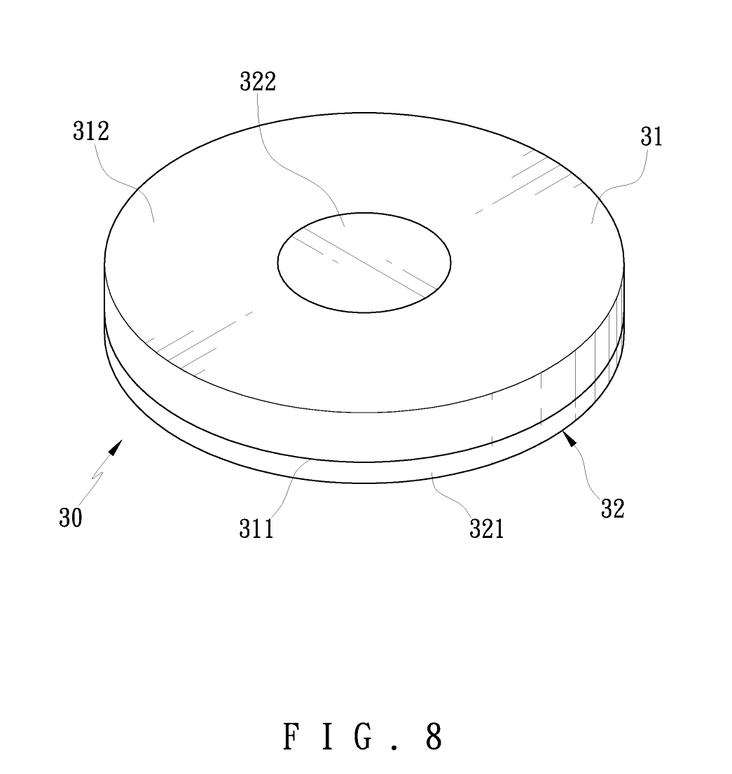

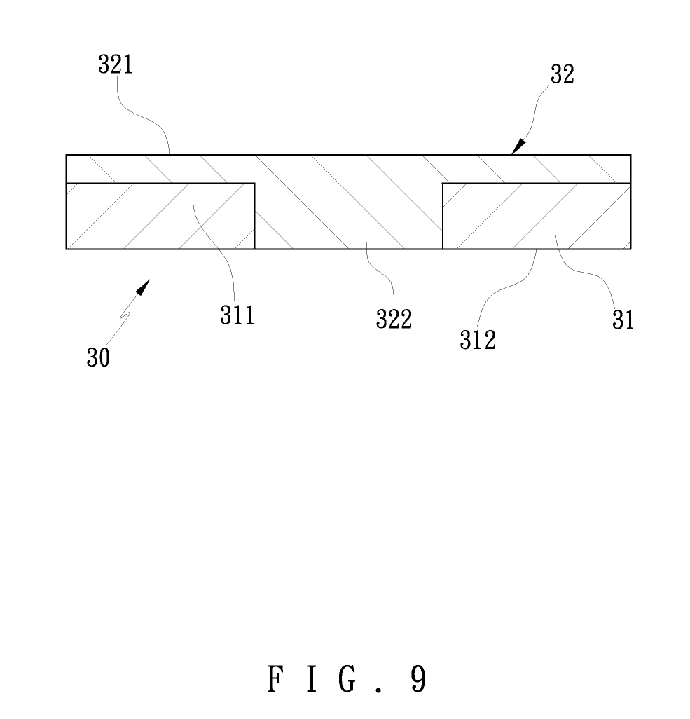

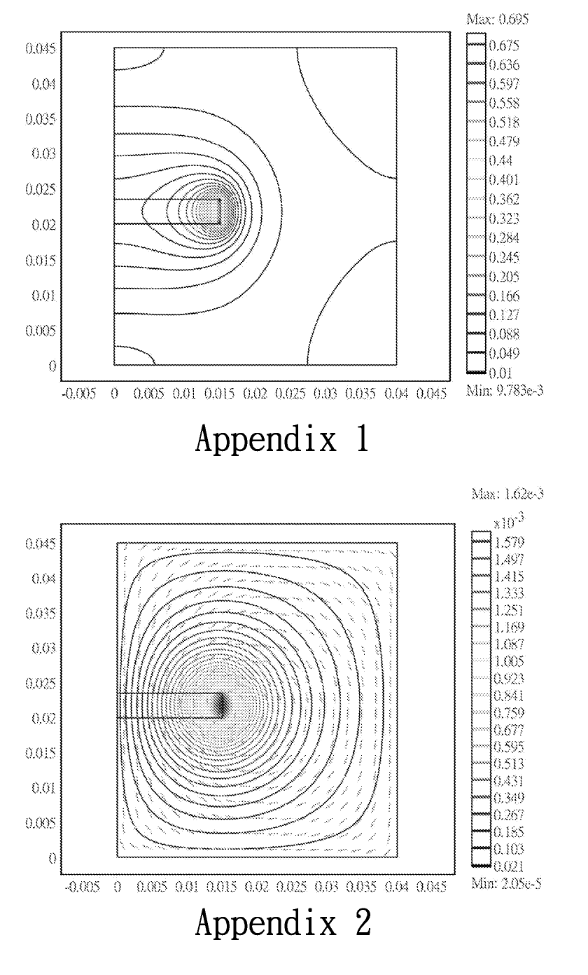

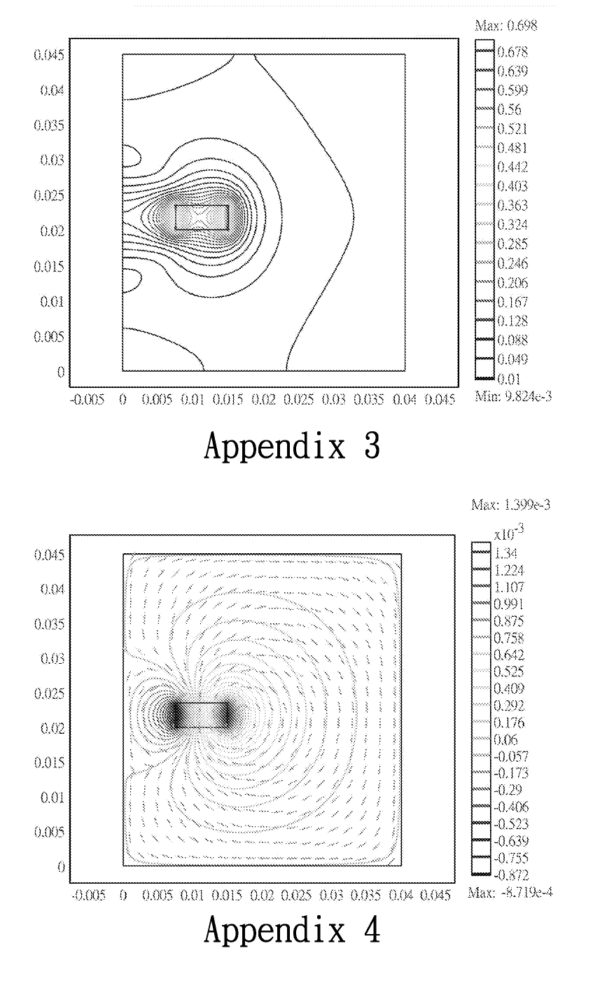

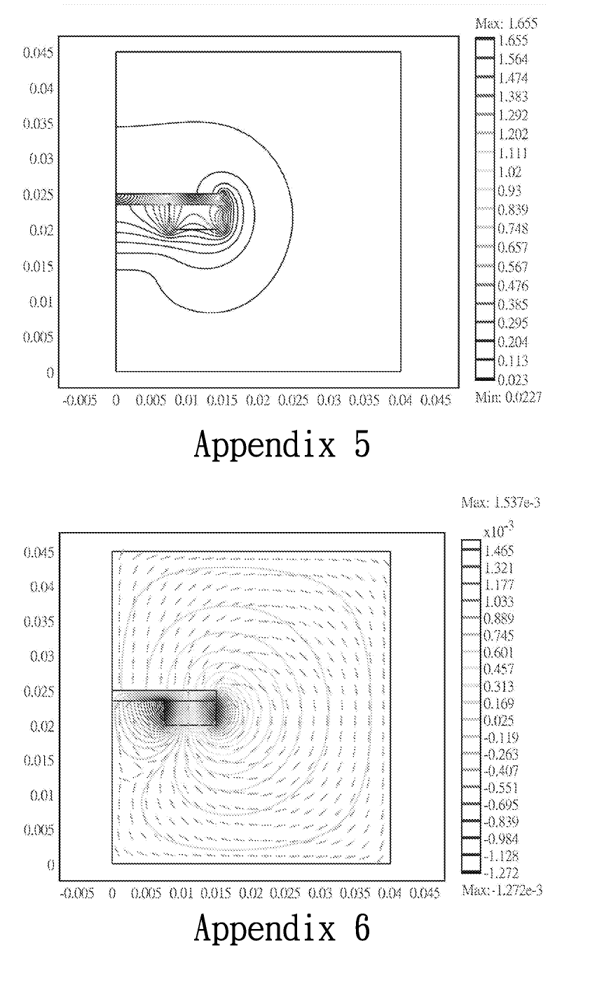

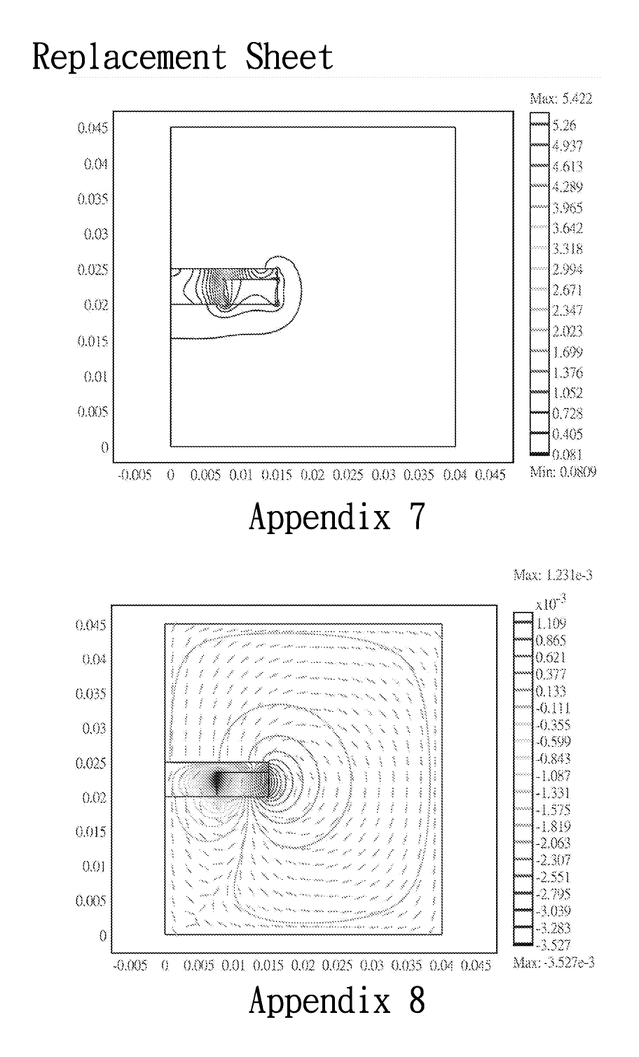

FIG. 2 is a cross sectional view of the conventional ring magnet;

FIG. 5 is a perspective view of a conventional magnet combining with an iron piece;

FIG. 6 is a cross sectional view of the conventional magnet combining with the iron piece;

FIG. 7 is a perspective view showing the exploded components of a magnetic assembly according to a preferred embodiment of the present invention;

FIG. 8 is a perspective view showing the assembly of the magnetic assembly according to the preferred embodiment of the present invention;

FIG. 9 is a cross sectional view showing the assembly of the magnetic assembly according to the preferred embodiment of the present invention;

Appendix 1 shows a table of a distribution of a magnetic flux density of a conventional solid magnet;

Appendix 2 shows a table of distributions of a magnetic potential and magnetic lines of the conventional solid magnet;

Appendix 3 shows a table of a distribution of a magnetic flux density of a conventional ring magnet;

Appendix 4 shows a table of distributions of a magnetic potential and magnetic lines of the conventional ring magnet;

Appendix 5 shows a table of a distribution of a magnetic flux density of a conventional magnet combining with an iron piece;

Appendix 6 shows a table of distributions of a magnetic potential and magnetic lines of the conventional magnet combining with the iron piece;

Appendix 7 shows a table of a distribution of a magnetic flux density of the magnetic assembly according to the preferred embodiment of the present invention;

Appendix 8 shows a table of distributions of a magnetic potential and magnetic lines of the magnetic assembly according to the preferred embodiment of the present invention.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

Referring to FIGS. 7-9, a magnetic assembly 30 according to a preferred embodiment of the present invention comprises a magnetic member 31 and a magnet guiding member 32; the magnetic member 31 is made of a magnetic material and is formed in a ring shape and includes two end portions with two different magnetic poles respectively; in this embodiment, the magnetic member 31 is made of iron, cobalt, nickel or rare earths and includes a first end portion 311 used as a N pole and a second end portion 312 used as a S pole; the magnetic member 31 includes a groove 313 fixed thereon in an axial direction and formed in a circle or a square shape, an exterior of the magnetic member 31 and an exterior of the groove 313 have magnetic fields surrounding therearound in different directions individually; in this embodiment, the groove 313 of the magnetic member 31 is circular; and the magnet guiding member 32 is made of a metal material with a magnetic permeability and includes a plate 321, the plate 321 is in response to a profile of an outer periphery of the magnetic member 31 to contact with the second end portion 312 of the magnetic member 31, and the plate 321 also includes a post 322 extending outward therefrom, the post 322 corresponds to a shape of the groove 313 of the magnetic member 31 and is fitted into the groove 313 of the magnet guiding member 32, a surrounding path of a magnetic field of the magnetic member 31 is guided and gathered by using the plate 321 and the post 322 of the magnet guiding member 32 so that between the magnetic member 31 and the magnet guiding member 32 generates a magnetic flux density region.

As shown in FIG. 9 and Appendixes 7 and 8, ½ cross section of the magnetic assembly 30 is captured, and distributions of a magnetic flux density and a magnetic potential of the magnetic assembly 30 are analyzed. As illustrated in Appendix 7, when a magnetic line of force of the magnetic member 31 resulting from a magnetic field passes through the plate 321 and the post 322 of the magnet guiding member 32, the magnetic line of the force of the magnetic member 31 is guided by the plate 321 and the post 322 to gather in a connection zone of the magnetic member 31 and the magnet guiding member 32 so that between the magnetic member 31 and the magnet guiding member 32 generates the magnetic flux density region, and a maximum value of the magnetic flux density is 5.422 Wb/m². Referring to Appendix 8, interiors of the magnetic member 31 and the magnet guiding member 32 generate magnetic lines surrounding in a first direction (i.e., an anti-clockwise direction), a value of magnetic potential relative to an intensive area of a magnetic flux of the first direction where forms a higher magnetic field is −3.5276° Wb/m (this negative value represents the first direction), exteriors of the magnetic member 31 and the magnet guiding member 32 generate magnetic lines surrounding in a second direction (i.e., an clockwise direction), a value of magnetic potential relative to an intensive area of a magnetic flux of the second direction where forms a higher magnetic field is −1.2316° Wb/m (this positive value represents the second direction). Accordingly, a maximum value of the magnetic potential of the magnetic assembly 30 relative to a highest magnetic field forms in the magnetic flux density region is −3.5276° Wb/m (this negative value represents the first direction), so this maximum value is greater than a conventional solid magnet, a conventional ring magnet or a conventional magnet combining with an iron piece; due to the magnet guiding member 32 includes plural magnetic zones, directions of magnetic moments of the plural magnetic zones of the magnet guiding member 32 are not the same, when the magnetic field of the magnetic member 31 passes through the plate 321 and the post 322 of the magnet guiding member 32, the magnet guiding member 32 is magnetized by the magnetic field of the magnetic member 31 so that the directions of the magnetic moments of the plural magnetic zones of the magnet guiding member 32 are identical to a direction of the magnetic field of the magnetic member 31 to enhance a strength of the magnetic field of the magnetic assembly 30.

Thereby, the magnetic assembly of the present invention is capable of applying the plate and the post of the magnet guiding member to guide and gather the surrounding path of the magnetic field of the magnetic member so that between the magnetic member and the magnet guiding member generates the magnetic flux density region. Also, the magnet guiding member is magnetized by the magnetic field of the magnetic member so as to enhance the strength of the magnetic field of the magnetic assembly. In addition, the maximum values of the magnetic flux density and the magnetic potential of the magnetic assembly are greater than a conventional solid magnet, a conventional ring magnet or a conventional magnet combining with an iron piece to enhance magnetic power and to save magnetic material.

While we have shown and described various embodiments in accordance with the present invention, it is clear to those skilled in the art that further embodiments may be made without departing from the scope of the present invention.

1. A magnetic assembly comprising:
a magnetic member including two end portions with two different magnetic poles respectively and a groove fixed thereon in an axial direction, an exterior of the magnetic member and an exterior of the groove having magnetic fields surrounding therearound in different directions individually;
a magnet guiding member with a magnetic permeability including a plate to contact with one end of the magnetic member, and the plate including a post extending outward therefrom to be fitted into the groove of the magnet guiding member;
wherein the plate of magnet guiding member corresponds to a profile of an outer periphery of the magnetic member;
wherein the post of the magnet guiding member corresponds to a shape of the groove of the magnetic member;
a surrounding path of a magnetic field of the magnetic member is guided and gathered by using the plate and the post of the magnet guiding member so that between the magnetic member and the magnet guiding member generates a magnetic flux density region.

2. The magnetic assembly as claimed in claim 1, wherein the magnetic member is a ring magnet.

3. The magnetic assembly as claimed in claim 1, wherein the groove of the magnetic member is circular.

4. The magnetic assembly as claimed in claim 1, wherein the groove of the magnetic member is square.

5. The magnetic assembly as claimed in claim 1, wherein the magnetic member includes a first end portion used as a N pole and a second end portion used as a S pole.

6. (canceled)

7. (canceled)
